(19) United States
(12) Patent Application Publication
(10) Pub. No.: US 2005/0255353 A1
(43) Pub. Date: Nov. 17, 2005

(54) Fuel-cell power system

(76) Inventors: Masahiro Komachiya, Hitachinaka (JP); Kenji Takeda, Hitachi (JP); Masaya Ichinose, Hitachiota (JP); Motoo Futami, Hitachiota (JP); Yasuyuki Arimitsu, Kure (JP); Hiroshi Yatabe, Kure (JP); Yoshihide Kondo, Ondo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/049,756

(22) Filed: Feb. 4, 2005

(30) Foreign Application Priority Data
Feb. 6, 2004 (JP) 2004-030994

(51) Int. Cl. H01M 8/00

(52) U.S. Cl. 429/22; 429/12; 429/24

(57) ABSTRACT

A fuel-cell power system includes a fuel cell stacks, a power conversion unit for controlling and receiving the current from the fuel-cell stacks, a hydrogen production unit for supplying hydrogen to the fuel-cell stacks, and an operation unit for carrying out the operation with a simulated load connected for selected one of an arbitrary time and a predetermined time before the service operation of the fuel-cell power system, thereby the hydrogen production unit having the combustor for refluxing and combusting an anode off-gas is started in stable fashion at the same time as the system.

### BACKGROUND OF THE INVENTION

The present invention relates to a technical field dealing with a power system using a fuel cell and an operation method thereof.

In a power system using a fuel cell or especially a home fuel-cell power system, hydrogen as a fuel is difficult to supply and store, and therefore a method has been studied to generate power by producing hydrogen on site. The production of hydrogen mainly utilizes the endothermic reaction of a catalyst. For producing hydrogen efficiently, therefore, it is necessary to supply heat without any waste to the reacting parts. On the other hand, it is difficult to operate a fuel cell stack in such a manner as to consume 100% of hydrogen supplied unless a closed-loop operation is employed, and the hydrogen energy remaining unused for power generation is desirably recovered. With these facts as a background, a method is generally known, in which a hydrogen production unit comprises a combustor for combusting the residual hydrogen (anode off-gas) in the exhaust gas of the anode of the fuel cell with air.

The heat generated by the combustion is supplied to the endothermic reaction process for hydrogen production. The response delay may be caused, however, by the heat capacity of the hydrogen production unit. Also, the amount of residual hydrogen, i.e. the amount of hydrogen returned from the fuel cell stack changes with the amount of power generated by the stack, and therefore the amount of heat generated in the combustor is varied depending on the condition of load connection. In order to operate the hydrogen production unit stably, therefore, the reaction is required to be balanced in consideration of the amount of hydrogen returned. Special care is required at the time of starting the hydrogen production unit when the operation rises to stable hydrogen production.

A conventional method of starting the fuel cell power system is described, for example, in JP-A-2000-285943. According to this operation method, the power generated in the fuel cell stack at the time of starting the fuel-cell power system is temporarily supplied to a test load, and after confirming that the voltage of the fuel cell stack is not decreased below a predetermined voltage, the test load is then canceled and the service operation is started.

The temporary power supply to the test load and the confirmation of the voltage of the fuel cell stack are repeated several times to ascertain that a sufficient amount of hydrogen is supplied to the fuel cell stack. After that, power generation for an external load is started. Therefore, the life of the fuel cell stack is not easily shortened.

The method of starting the fuel-cell power system described above, however, poses the problem that despite the small shortening of the life of the fuel cell stack, the stable operation of the hydrogen production unit is difficult to achieve. To stabilize the hydrogen production unit, the operation of the hydrogen production unit is desirably balanced in the presence of the hydrogen returned from the fuel cell stack (anode off-gas). In the case where the hydrogen production unit is started in the absence of the return hydrogen, the combustion state of the combustor would suddenly change with the start of supplying the return hydrogen, and the heat balance in the hydrogen production unit would undergo a considerable change.

In the case where the conventional starting method is used in the presence of the return hydrogen as described above, the amount of hydrogen returned to the hydrogen production unit changes each time a test load is connected, and therefore stabilization is not easily achieved. An unreasonable operation of the hydrogen production unit would lead to a shorter life of the catalyst used in the hydrogen production unit and is not desirable. In the embodiment described in JP-A-2000-285943, a hydrogen cylinder is used as a fuel source for the fuel cell stack. This problem is encountered in the combination of the hydrogen production unit and the fuel cell stack including a home system for producing hydrogen by reforming the city gas.

### SUMMARY OF THE INVENTION

This invention has been achieved in view of the problems described above. According to this invention, before starting the service operation of a fuel-cell power system, the operating condition with a simulated (or dummy) load connected is inserted during an arbitrary time or a predetermined time A. In the process, the anode off-gas of the fuel cell stack is combusted by being refluxed to the combustor of the hydrogen production unit thereby to stabilize the operation of the hydrogen production unit including the combustor. The service operation is defined herein as the stable operation of the hydrogen production unit and the fuel cell stack connected to a normal load for system users. In other words, the service operation is the state of the fuel-cell power system ready for starting the steady operation of power supply to users or in the steady operation.

The arbitrary time is defined as the time required before the temperature of the catalyst of the hydrogen production unit is observed with a sensor, a predetermined state of the catalyst is detected and it is determined that the service operation can be started. In the simulated operation for the arbitrary time, a parameter indicating the stabilization of the hydrogen production unit is set in advance, and when the parameter detected by a monitor indicates a stabilized state (when the detection value has reached a predetermined threshold value, for example), the simulated load operation is finished, thereby making possible to start the automatic operation smoothly. The predetermined time A, on the other hand, is defined as the time required for stabilization and determined in advance under various conditions. By selecting the conditions for the simulated operation, the automatic operation can be started. This predetermined time A may be varied from one hydrogen production unit to another. Further, the arbitrary time or the predetermined time A may change in the summer and winter seasons, and therefore the value thereof is desirably switched by reference to the temperature of the atmosphere and the tap water.

Specifically, according to this invention, there is provided a fuel-cell power system comprising a fuel cell stack, a power conversion unit controlling the current from the fuel cell stack, a hydrogen production unit for supplying hydrogen to the fuel cell stack and a means for performing the operation connected with a simulated (or dummy) load for the arbitrary time or the predetermined time A before the service operation of the fuel-cell power system. The value of the arbitrary time or the predetermined time A is desirably switched based on the temperature of the atmosphere or water.

According to this invention, there is provided a fuel-cell power system, wherein the anode off-gas of the fuel cell stack is combusted by being refluxed (or re-circulating) to the combustor of the hydrogen production unit with a simulated load connected thereto before the service operation of the fuel-cell power system. In this fuel-cell power system, the optimum time required for starting the hydrogen production unit including the combustor in stable fashion is secured before the service operation. Since a simulated load is employed, the power generating conditions most suitable for the stabilized collaboration between the hydrogen production unit and the stack can be set independently of the power demand.

According to this invention, there is provided a fuel-cell power system further comprising at least one of a power storage unit and a hot water storage unit as a simulated load. In the operation of the system connected with the simulated (or dummy) load, the advisability of starting the service operation is desirably determined with reference to at least one of the amount of hot water stored in the hot water storage unit and the amount of power stored in the power storage unit.

In the case where it is determined that the service operation cannot be started, a predetermined partial load operation is desirably started while suppressing the amount of power generated and heat recovered. Once it is determined that the service operation can be started, on the other hand, the current is controlled by the power conversion unit up to a target output power value calculated based on the value of the smoothed or averaged power load change.

In the fuel-cell power system, the transition from the simulated (or dummy) load operation required for starting the operation of the hydrogen production unit including the combustor in stable fashion to the service operation or the hot standby operation (predetermined partial load operation) is determined by reference to the amount of hot water and power stored. Specifically, checking the free capacity of hot water storage and the free capacity of power storage required for maintaining the balance between demand and supply of heat and power, the continuation or suspension of the operation is determined based on the information on whether the required free capacity is available or not.

The amount of hydrogen produced by the operation with the simulated load connected can be set to a smaller value than the amount of hydrogen produced by the rated operation of the fuel-cell power system. In this fuel-cell power system, the hydrogen production unit is started from the operating conditions lower than the rating, thereby facilitating the start of the stable operation of the hydrogen production unit. In the case where a simulated load operation is performed with a partial load equivalent to an intermediate output, the hydrogen production unit is smoothly started and the subsequent service operation or hot standby operation (predetermined partial load operation) can be entered with a smaller change of the operating conditions regardless of whether the load is increased or decreased.

Also, the power storage unit such as the rechargeable battery can be used as a simulated (or dummy) load. As a result, at least part of the required power supplied to the auxiliary equipment at the time of starting the system can be acquired from the power storage unit.

In the fuel-cell power system, the power generated by the operation using the rechargeable battery or the like as a simulated load capable of storing power may be discharged and utilized at another chance. Especially, the power, which has been stored in the power storage unit by the end of the system operation, can be used as part of power supplied to the auxiliary equipment when restarting the system. Also, the free capacity available at the particular time is charged by the simulated load operation and therefore the wasteful operation is avoided.

According to this invention, there is provided a fuel-cell power system comprising at least one of a power storage unit and a hot water storage unit, wherein the advisability of starting or continuing the service operation (with a load connected) is determined by reference to at least one of the amount of hot water stored in the hot water storage unit and the amount of power stored in the power storage unit. In the case where it is determined that the operation is impossible, a predetermined partial load operation mode is entered, and the advisability of restarting the operation is determined at each arbitrary time or predetermined time B. Upon lapse of the arbitrary time or predetermined time C without determining the restart of the system, the system can be stopped. The value of at least one of the arbitrary time, the predetermined time B and the predetermined time C can be switched based on the air temperature or water temperature.

In the fuel-cell power system, after transition from the simulated load operation to the hot standby operation (predetermined partial load operation), the operation can be stopped if the hot standby mode is further continued for a predetermined time length. The hot standby operation hardly produces a high system efficiency, and therefore the duration of this mode is limited to assure an efficient system operation. This operation procedure is applicable not only at the time of starting the system but also in the case where the system operation is difficult to continue.

According to this invention, there is provided a home fuel-cell power system using a fuel-cell power system, wherein the operation of the hydrogen production unit for reforming the city gas can be started easily in stable fashion. Since the unreasonable operation of the hydrogen production unit is not performed, the service life of the catalyst used in the hydrogen production unit is not shortened extremely.

According to this invention, the operation of the hydrogen production unit including the combustor can be stabilized before starting the service operator, not by using service load but by employing simulated (or dummy) load. Since the transition from simulated load to the service load is rather smooth compared with the case of sudden connection to the service load, a load-following operation not imposing an unreasonable burden on the hydrogen production unit can be performed, and the service life of the catalyst used for the hydrogen production unit is not extremely shortened.

Other objects, features and advantages of the invention will become apparent from the following description of the embodiments of the invention taken in conjunction with the accompanying drawings.

### BRIEF DESCRIPTION OF THE DRAWINGS

FIG. 1 shows the state transition from the full stop mode to the start of the service operation of a fuel-cell power system according to a first embodiment of the invention.

FIG. 2 shows an example of the system configuration and the state of the running-in operation according to the first embodiment of the invention.

FIG. 3 shows an example of determination to start the service operation according to the first embodiment of the invention.

FIG. 4 shows an example of setting the service operation load according to the first embodiment of the invention.

FIG. 5 shows the state transition after the fuel-cell power system enters the minimum partial load operation (hot standby operation) according to a second embodiment of the invention.

FIG. 6 shows an example of the application of the fuel-cell power system according to the invention to a stationary distributed power supply arranged in each home.

### DETAILED DESCRIPTION OF THE EMBODIMENTS

Typical embodiments of the invention are described below.

(1) According to a first aspect of the invention, there is provided a fuel-cell power system comprising a fuel cell stack, a power conversion unit controlling the current from the fuel cell stack, a hydrogen production unit for supplying hydrogen to the fuel cell stack and a maintaining unit for maintaining a simulated (or dummy) load for an arbitrary time or a predetermined time A before the service operation of the fuel-cell power system. In this case, the operation with a simulated load is desirably conducted while combusting by refluxing the anode off-gas to the hydrogen production unit. The completion of the operation with a simulated load is determined by detecting the stabilized state (for example, by the catalyst temperature) of the hydrogen production unit and the stabilized state (whether the hydrogen fuel has been supplied to the whole stack or not) of the fuel cell stack.

(2) According to a second aspect of the invention, there is provided a fuel-cell power system comprising a fuel cell stack, a power conversion unit controlling the current from the fuel cell stack, a hydrogen production unit for supplying hydrogen to the fuel cell stack and a means for carrying out the operation with a simulated load connected for an arbitrary time or a predetermined time A until the hydrogen production unit is stabilized before the service operation of the fuel-cell power system. In this case, the stabilization of the operation of the hydrogen production unit is defined above. Also, the anode off-gas is desirably refluxed to the combustion chamber of the hydrogen production unit as described above.

(3) According to a third aspect of the invention, there is provided a fuel-cell power system comprising a fuel cell stack, a power conversion unit by controlling the current from the fuel cell stack, and a hydrogen production unit for supplying hydrogen to the fuel cell stack, wherein the anode off-gas of the fuel cell stack is combusted by being refluxed or re-circulating to the combustor of the hydrogen production unit while performing the operation with a simulated load connected before the service operation of the fuel-cell power system. This operation with a simulated load is desirably continued especially until the hydrogen production unit and the fuel cell stack are stabilized.

(4) According to a fourth aspect of the invention, there is provided a fuel-cell power system comprising at least one of a power storage unit and a hot water storage unit, a determination unit for determining the advisability of starting or continuing the service operation (with a load connected) by reference to at least one of the amount of hot water stored in the hot water storage unit and the amount of power stored in the power storage unit, a start unit for starting a predetermined partial load operation and determining again the advisability of restarting the operation for each arbitrary time or predetermined time B upon determination that the operation is impossible and a stop unit for stopping the system upon lapse of the arbitrary time or predetermined time C as long as the determination of the restarting determination unit remains negative.

(5) According to a fifth aspect of the invention, there is provided a fuel-cell power system comprising at least one of a power storage unit and a hot water storage unit and, preferably, a control unit for determining the advisability of starting the service operation by reference to at least one of the amount of power stored in the power storage unit and the amount of hot water stored in the hot water storage unit according to the operating conditions with the simulated (or dummy) load connected.

(6) According to a sixth aspect of the invention, there is provided a fuel-cell power system, wherein upon determination that the service operation can be started, the current is controlled by the power conversion unit to a target output power value calculated based on the value of the smoothed power load change, wherein the amount of hydrogen produced by the operation with the simulated load connected is set to a lower value than the amount of hydrogen produced by the rated operation of the system, and wherein at least part of the power supplied to the auxiliary equipment required for starting the fuel-cell power system is acquired from the power storage unit.

With the fuel-cell power system according to the invention, the operation with a simulated load connected is continued or carried out for an arbitrary time or predetermined time A before the service operation (with a load connected) of the fuel-cell power system. In the process, the anode off-gas of the fuel cell stack is combusted by being refluxed or re-circulated to the combustor of the hydrogen gas production unit. The arbitrary time or predetermined time A is the time required for stabilizing the hydrogen production unit or both the hydrogen production unit and the fuel cell stack and varies from one hydrogen production unit to another.

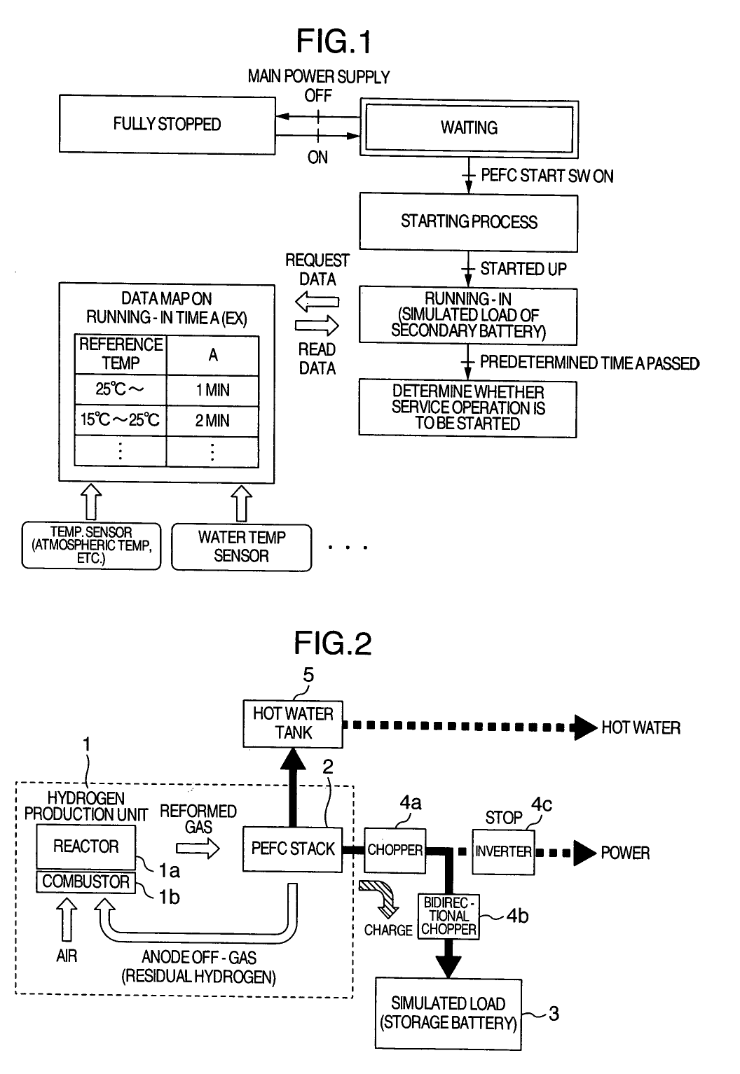

An embodiment of the invention is explained in detail below with reference to the drawings. FIG. 1 shows the state transition from the full stop to the start of the service operation of the fuel-cell power system according to a first embodiment of the invention.

The fuel-cell power system installed in the initial state is completely stopped. By switching on the main power, the fuel-cell power system enters a waiting mode. In the waiting mode, the water heater attached to the fuel-cell power system can perform the hot water supply service operation independently, but the fuel cell is incapable of generating power or recovering heat. In this waiting mode, the microcomputer for controlling the fuel cell power system is driven, and therefore the user can determine the turning on of the system starting switch and activates the system starting process. In the waiting mode, the control microcomputer is subjected to self-diagnosis or the connection and operation of the peripheral devices can be checked by communication.

The transition from the waiting mode to the starting process can be effected by turning on a start switch or automatically by setting a timer. Instead of setting the timer every day in the same way, the starting time may be set based on the calendar in the control unit.

The starting process is the one for the fuel-cell power system to transfer to the mode capable of generating power and recovering heat. In the case under consideration, for example, the water heated by the heater is circulated in the fuel cell stack, which is increased to the temperature suitable for power generation, while at the same time starting the hydrogen production unit for supplying hydrogen to the fuel cell stack. The heater required for generating hot water is turned on without waste only in the case where the fuel cell stack is not higher than a predetermined temperature.

The starting process is completed and the next mode is entered when the catalyst of the hydrogen production unit is increased to a predetermined temperature at which stable reaction is assured and the fuel cell stack also can generate power while the reformed gas containing hydrogen can be supplied to the fuel cell stack. The state in which the reformed gas can be supplied is defined as a state in which the reformed gas containing hydrogen of predetermined concentration can be generated and the gas components such as carbon monoxide adversely affecting the electrocatalyst of the fuel cell stack have been reduced to less than a predetermined concentration. In the starting process described above, a predetermined amount of fuel and air can be supplied to and combusted in the combustor attached to the hydrogen production unit. Since the reformed gas is not yet supplied to the fuel cell stack, however, the fuel cell off-gas cannot be actually refluxed and combusted as a fuel.

Comparison between the combustion of the fuel cell off-gas refluxed and the combustion of another fuel shows the following difference. Specifically, although the calorific value of the fuel cell off-gas can be combined with that of another fuel with comparative ease, it is difficult to combine other gas components such as water contained in a considerable amount in the fuel cell off-gas. The fuel cell off-gas containing much water is generally combusted not easily. In starting the hydrogen production unit, therefore, the thermal balance required for reaction is maintained with the fuel cell off-gas refluxed and combusted in advance. After that, the service operation is started. Then, the system can be maintained in stable state without disrupting the thermal balance before starting the service operation.

Especially in the home fuel-cell power system, the system operation is desired which can follow the home power load undergoing a great change, and it is difficult to secure a thermal balance of an unstable hydrogen production unit after starting the service operation. The catalyst temperature of the hydrogen production unit is directly related to the concentration and amount of hydrogen produced and therefore the thermal balance is important. Once stabilized, however, each hydrogen production unit can be operated by following the load by changing the amount of hydrogen produced with an optimum sequence. In the fuel-cell power system according to this invention, upon completion of the starting process described above, the running-in is started and then the service operation is started in keeping with the requested power load.

The running-in is the mode in which the reformed gas is supplied to the fuel cell stack from the hydrogen production unit, a predetermined current is controlled by a power conversion unit by controlling the current from the fuel cell stack, and the anode off-gas of the fuel cell stack is refluxed to and combusted in the combustor of the hydrogen production unit. The current controlled is not supplied to the user including the home load, but consumed by or stored in a simulate (or dummy) load.

The simulated (or dummy) load may be an auxiliary equipment such as a pump, a fan or blower used for the fuel-cell power system, a peripheral electrical appliance operated in collaboration with the fuel-cell power system, a thermoelectric conversion unit such as an electric heater or a power storage unit such as the rechargeable battery. In the case where the auxiliary equipment or the peripheral electrical appliances are used as a simulated load, the shortage of power can be supplemented by a separate power system or the grid. Then, the amount of power generated by the fuel cell stack need not be determined according to the auxiliary equipment or the peripheral electrical appliances. In the case where electricity is converted to heat by an electric heater or the like, the water stored in a hot water tank is heated directly or indirectly. As a result, the electricity can be stored in the form of hot water (heat). In the case where the power storage unit such as the rechargeable battery is used, the power generated is stored in the particular power storage unit and can be discharged whenever required. In the system operation, therefore, the amount of power generated can be desirably adjusted.

In the running-in described above, the anode off-gas left after actual power generation in the fuel cell stack is refluxed or recirculated to and combusted in the combustor of the hydrogen production unit. As long as stable combustion can be achieved by the gas of the particular gas composition, the normal service operation can be performed in stable fashion.

In the case where the fuel cell stack has not sufficiently increased in temperature at the time point of starting the running-in, the running-in can assist in temperature increase. This is because power is actually generated by the fuel cell and the heat is also generated by the power generation in the running-in. In the case where the fuel-cell stack is operated at a typical temperature or an average temperature of 70° C., for example, the running-in is started at about 50° C. or lower temperature. In the case where a sufficient heat generation can be expected from the running-in, the heat may be recovered as hot water into the hot water tank.

The amount of hydrogen produced and the amount of the control current during the running-in can be set to a value at which the hydrogen production unit including the combustor can be easily stabilized. As an example, the amount of hydrogen and current are set to a value corresponding to the partial load of about 50% for the rated load (100%). Then, the amount of hydrogen produced gradually increases from the starting point, and therefore the stable state can be entered smoothly and rapidly.

No special state is provided but a given partial load for the running-in. Then, the control operation of the hydrogen production unit is not complicated. Also, as long as the system is set to an intermediate load of about 50%, on the other hand, the subsequent load change is small, upward or downward, and therefore the operation change can be reduced.

Also, the hydrogen production unit can be started aimed at the optimum hydrogen amount required for operation with a simulated load as a target. Therefore, the hydrogen production unit can be started easily in stable fashion. This target value is generally varied depending on the type of the hydrogen production unit, and preferably be adjusted for each hydrogen production unit even of the same type.

The completion of the running-in can be determined by detecting the temperature of the temperature sensor arranged in the catalyst portion of the hydrogen production unit (with the operation with a simulated load continued for an arbitrary time). More practically, however, the running-in may be completed upon lapse of a predetermined time from the start thereof. The time during which the process is continued is predetermined, and therefore the control operation is not disturbed even in the case where the catalyst temperature temporary undergoes a change. Also, a new sensor or processing means is not required and therefore the system configuration is simplified.

The predetermined time depends on the hydrogen production unit and the piping length. The time before stabilization determined experimentally in advance can be employed as the predetermined time. In the system controlled by the microcomputer, the time is measured by counting the elapsed time with a time counter, after which the service operation is entered.

The predetermined time described above depends on the season as well as the hydrogen production unit and the system configuration. The predetermined time can be set to a long time in advance to secure stabilization with a margin applicable to all seasons, or more preferably set to an optimum time adjusted for each season. The concept of the predetermined time may be replaced with the concept of the arbitrary time, as described above.

In the embodiment shown in FIG. 1, the running-in time A can be switched based on the information from a temperature sensor for measuring the atmospheric temperature or a water temperature sensor for measuring the temperature of tap water. As an example, the running-in time A for a referred temperature is stored in the form of a map, and based on a data request at the time of starting the running-in, the temperature data is read. The reference temperature may be either the atmospheric temperature or the water temperature, or the result calculated from these data.

The temperature sensor for measuring the atmospheric temperature may be arranged either outside or inside a system housing. As an alternative, the atmospheric temperature may be measured using a thermistor arranged on the control unit board. The temperature actually contributing to the stabilization of reaction is the internal temperature of the hydrogen production unit. In place of the atmospheric temperature sensor signal, therefore, a thermocouple signal for controlling the hydrogen production unit may be used. The time A before complete running-in is changed by reference to the catalyst temperature before or at the time of complete starting of the operation. Then, the service operation can be started earlier in the case where the catalyst is already warmed as at the time of restarting the operation.

The water temperature sensor, installed in such a manner as to measure the temperature of the tap water supplied to the water heater attached to the hot water tank or the reheating unit, can detect different seasons including summer, winter or an intermediate season. In the case where the catalyst used for hydrogen production develops a significant secular variation, the map described above can be changed in accordance with the number of times the system operation is started and stopped.

In any case, each hydrogen production unit can be adjusted easily by rewriting or adding to the map in software fashion. Similarly, in the case where the various information are combined for determination, they may be formed collectively as a map. The information in great amount, however, may be stored as functions instead of as a map. The predetermined time A, which was described as the time from the start of the running-in, may alternatively be the time from the beginning of the starting process. In this case, the time required for starting may be determined in advance according to the atmospheric temperature, the water temperature or the catalyst temperature before starting the operation. Then, the sum of the time required for the starting process and the running-in can be set as the predetermined time A. The two types of time can of course be set independently of each other.

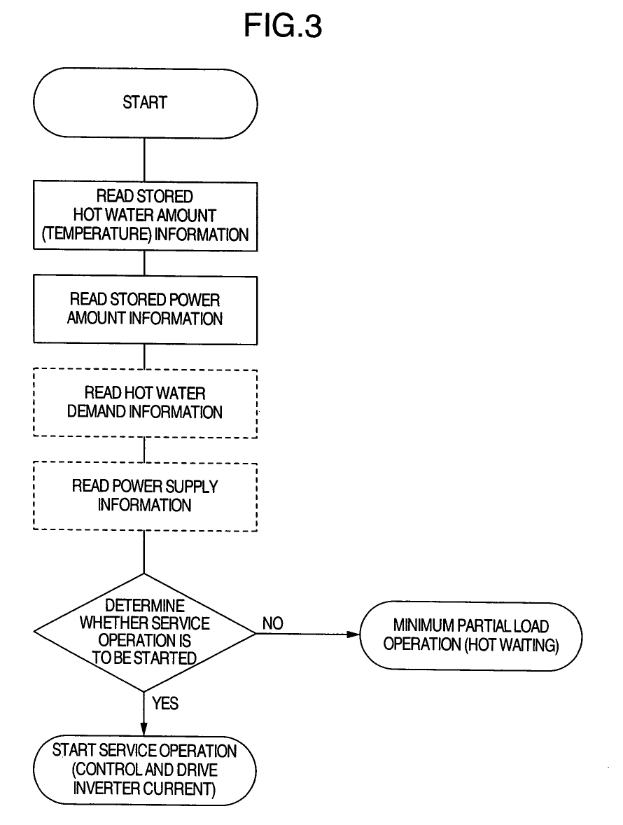

In the embodiment shown in FIG. 1, it can be further determined whether the service operation is to be started, without starting the service operation immediately after the running-in. In order to perform the operation appropriately following a home load as a fuel-cell power system, an appropriate free capacity is desirably available in the power storage unit and the hot water storage unit. Therefore, the service operation is started only after checking to see that the power storage unit and the hot water storage unit have an appropriate free capacity before starting the service operation. In the case where it is determined that the service operation cannot be started, the state transition is caused by the method described later in FIG. 3 and the second embodiment of the invention.

The operation of the system is started despite the lack of knowledge whether the service operation is possible or not is as follows. Firstly, priority is given to the intention of the user to turn on the starting switch. Secondly, the required load power may change during the starting operation so that a load request may be issued at the end of the starting operation even in the absence of the power load at the time of starting the system. According to this system operation method, the system is started immediately after being turned on desirably for the user on the one hand, and the subsequent operation can be determined by the load condition after starting the system desirably for the system on the other hand.

In the fuel-cell power system according to the first embodiment of the invention described above, the running-in is entered upon completion of the starting process, and after continuing the running-in for an arbitrary time or predetermined time A, the service operation is started in response to the required power load. Therefore, the reaction of the hydrogen production unit can be stabilized and the temperature of the fuel cell stack can be increased sufficiently before the service operation. Especially, the anode off-gas of the fuel cell is refluxed and burnt in the combustor during the running-in period. Thus, the thermal balance of the hydrogen production unit including the combustor can be secured positively, and various load-following operations can be performed in stable fashion in the subsequent service operation.

Also, the amount of hydrogen produced in the running-in is set smaller than the amount of hydrogen produced during the rated operation of the system so that hydrogen is produced in a gradually increased amount from the start of the system operation. As a result, the steady state can be reached quickly and smoothly. Even in a home system subjected to a large change in the required load after starting the service operation, therefore, the hydrogen production unit can be started by setting a predetermined amount of hydrogen required for the simulated load operation as a target. As a result, the starting operation of the hydrogen production unit can be easily stabilized.

The predetermined time A is changed by reference to the atmospheric temperature, the tap water temperature and the number of times the system is started and stopped. Thus, the difference in stabilization time in a different season or due to the difference of time from the preceding stop to the restart and the catalyst deterioration with time can be corrected. As a result, the optimum running-in time or the starting time can be set.

Further, the service operation is not started immediately after the running-in but the time of determination as to whether the service operation is to be started or not is inserted. Thus, the system is started immediately after being turned on for the convenience of the user on the one hand, and the subsequent operation of the system can be determined according to the load condition after the system start for the convenience of the system on the other hand.

FIG. 2 is a diagram for explaining an example of the system configuration and the mode of the running-in according to the first embodiment of the invention. Reference numeral 1 designates a hydrogen production unit, numeral 1a a main reactor, and numeral 1b a combustor. Numeral 2 designates a polymer electrolyte fuel cell (PEFC) stack. Numeral 3 designates a storage battery such as a rechargeable battery constituting a simulated (or dummy) load. Numeral 4 designates a power conversion unit, numeral 4a a chopper for recovering power from the fuel cell stack 2, numeral 3b a bidirectional chopper for charging or discharging power to and from the storage battery 3 constituting the simulated load, and numeral 4c an inverter for the service operation. Numeral 5 designates a hot water tank for storing the hot water thermally recovered from the fuel cell stack 2. The bidirectional chopper 4b may be done without for an ordinary simulated load such as an electrical resistor. Even in the case where the storage battery is assumed as a simulated load, the bidirectional chopper 4b may be omitted similarly unless the charge/discharge operation is accurately controlled.

In the running-in according to the invention, the hydrogen production unit 1 produces a reformed gas containing hydrogen, supplies the reformed gas to the fuel cell stack 2, recovers the predetermined power from the fuel cell stack 2 with the chopper 4a of the power conversion unit, and charges the power into the storage battery 3 making up a simulated load through the bidirectional chopper 4b. In view of the fact that a predetermined current is derived from the fuel cell stack 2 by the chopper 4a, the storage battery 3 constituting the simulated load is charged through the bidirectional chopper 4b so that the voltage is not increased between the choppers 4a, 4b. In this process, the fuel cell stack 2 generates power by consuming hydrogen in an amount commensurate with the amount of the control current of the power conversion unit 4. The resulting heat is converted into drinkable hot water through a heat exchange unit not shown, and stored in the hot water tank 5. The hydrogen left without being consumed is refluxed to the combustor 1b as an anode off-gas and combusted with the air. The heat generated by the combustion is used for hydrogen production in the reactor 1a.

In view of the fact that the inverter 4c for the service operation is not connected, the power generated by the fuel cell stack 2 is stored in its entirety in the storage battery 3 making up a simulated load. In the presence of the load 3, the fuel cell stack can generate power in the same manner as if an actual load is connected. The anode off-gas obtained in this way is burnt in the combustor 1b. Once the operation of the hydrogen production unit is stabilized under this condition, the service operation can be started smoothly. The hot water required to be supplied can be obtained from the hot water tank 5 even during the running-in operation. In the case where the amount of the hot water remaining in the hot water tank runs short, the additional hot water can be supplied by reheating in a gas or electric water heater or the like.

In order to sufficiently charge the storage battery 3 making up a simulated load during the running-in operation, a free capacity is reserved in such a manner that at least part of the power supplied to the auxiliary equipment required to start the system can be acquired from the storage battery 3 at the time of starting the system. Once the storage battery is fully charged, power can be supplied directly to the DC-driven auxiliary equipment and the like as a simulated load. In the case where an auxiliary equipment driven by AC power constitutes a simulated load, on the other hand, power is supplied after DC-AC conversion by the inverter.

The power for the auxiliary equipment to start system can be acquired from the system power. In order to make sure that at least part of the required power for the auxiliary equipment to start the system is supplied from the storage battery 3, however, the amount of stored power is detected at the time of the preceding system stoppage, and in the absence of a sufficient amount of charged power, the storage battery 3 is charged before stopping the system. With the configuration and the state of the system subjected to the running-in according to the first embodiment of the invention described above, a power storage means such as the rechargeable battery is used as a simulated load for the running-in. Then, the power generated during the running-in can be stored and discharged as required, thereby improving the operating efficiency.

Also, in view of the fact that at least part of the power supplied to the auxiliary equipment as required at the time of starting the system is acquired from the power storage unit, a free capacity for charging required for the operation with a simulated load can be positively secured.

With reference to FIG. 3, an example of the determination as to whether the service operation is to be started or not according to the first embodiment of the invention is explained. In the process flow, the first step is to read the information on the amount of stored hot water and the amount of stored power. In order to operate the fuel-cell power system by appropriately following a load in home, a proper free capacity is desirably available in the power storage unit and the hot water storage unit. In view of this, the availability of the proper free capacity in the power storage unit and the hot water storage unit is ascertained before starting the service operation. The amount of stored power can be approximately detected from the estimation of the charge/discharge amount or the change in the storage battery characteristics. The amount of hot water stored, on the other hand, can be approximately detected by measuring the temperature of the hot water by the temperature detection unit such as a thermistor arranged in the hot water tank. Once the free capacity of the hot water tank and the storage battery detected from the amount of stored hot water and the amount of stored power, respectively, reach a predetermined value, the service operation is started.

For determining whether the service operation is to be started or not, the amount of supplied hot water and power as well as the amount of stored hot water and power may constitute an important factor. Even in the case where the power storage unit is almost fully charged, it may be that the operation should be better started if demand for power exists. The acquisition of the information on hot water supply and power supply is indicated by dotted lines.

The information on hot water supply and power supply can be acquired from the prediction based on the data base in and outside the system and/or the estimated value calculated from the past trend, instead of the actual measurement of the amount of hot water and power. As an example, in the case where the data base shows the trend of a generally low power demand during a particular time zone although the storage unit is almost fully charged and demand currently exists for power, then it can be determined that the service operation should not be entered. As another example, in the case where the amount of power stored is small but no power demand currently exists, the system can be operated efficiently by starting the service operation as long as the data base indicates that the power demand during a particular time zone generally tends to increase.

In an example of determination as to whether the service operation is to be started or not according to the first embodiment of the invention, the determination to start the service operation is made based on the available free capacity of the stored hot water amount and the stored power amount, the power supply situation and the prediction value thereof. As a result, the inconvenient cases can be avoided in which hot water is fully stored or the storage battery is fully charged, and the service operation becomes unable to be continued immediately after being started. Thus, the repeated starts and stops of the system which impose a great burden on the system are prevented, and an efficient operation can be performed. The starts and stops of the system lead to the deterioration of the catalyst of the hydrogen production unit and the fuel cell stack, and therefore are desirably suppressed.

In FIG. 3, whether the service operation is to be started or not is determined as described above, and in the case where the service operation is not to be started, the minimum partial load operation is started. Generally, the partial load operation decreases the amount of power generated and the amount of heat generated against the amount of heat radiated, and therefore the amount of heat recovered is reduced. In view of this, a mode of the partial load operation is selected in which the power generation corresponding to the power consumed by the auxiliary equipment and the amount of heat recovery substantially commensurate with the heat radiation loss are realized. In this way, the operation can be continued even in the case where the amount of hot water stored and the amount of power stored are substantially full. In the case where the operation cannot be continued, the system stop is unavoidable. By providing a hot waiting mode with the minimum partial load operation before transferring to the stop process, however, the frequent stops and restarts can be suppressed for a smaller burden on the system.

It is of course difficult to render the amount of power generation precisely coincident with the amount of power consumed by the auxiliary equipment or the amount of heat generation precisely coincident with the amount of heat loss of the system. Achievement of substantially the same state, however, can maintain the increase of both the amount of power stored and the amount of hot water stored virtually at zero, and therefore the hot waiting operation can be continued for a predetermined time.

In the determination of the advisability as to whether the service operation is to be started or not according to the first embodiment of the invention, assume that it is determined that the service operation cannot be started. Then, a predetermined partial load mode (minimum partial load operation) is started, so that the amount of power generation and the amount of heat generation can be suppressed. Even in the case where the amount of stored hot water and the amount of stored power are substantially full, therefore, the operation can be continued. Thus, the frequent stops and restarts are suppressed. Also, since one of the partial load modes is selected as a hot waiting mode but not a special mode, the system control operation is not complicated.

In FIG. 3, assume that the advisability of starting the service operation is determined and that it is determined that the service operation can be started. The current control operation of the inverter is activated, and power commensurate with the real load starts to be supplied to external devices.

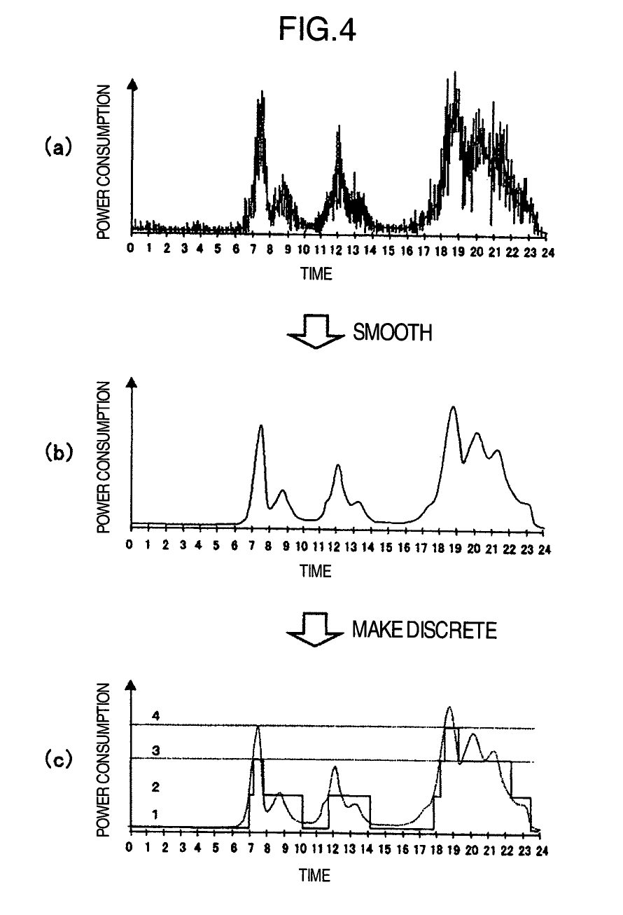

FIG. 4 shows an example of setting the service operation load according to the first embodiment of the invention. In the case where it is determined that the service operation can be started, the current is controlled by the power conversion unit up to a predetermined target electric energy from the fuel cell stack. This target electric energy is set in such a manner that the change in power load is smoothed and then set to be discrete.

In the graphs of FIG. 4, the ordinate represents the power consumption and the abscissa the time. The uppermost graph (a) shows a model of the load pattern in home. This graph has the feature that spikes of power change are superposed on the relatively slow change of power consumption. These spikes of power change are generated by the switching operation of home electric appliances. The central graph (b) shows a version of the graph (a) averaged and smoothed along time axis. In this graph (b), the slow change is extracted as a feature. The lowest graph (c) shows a further discrete version of the graph (b). The amount of power generated by the fuel-cell power system can be changed continuously. In view of the response delay of the system, however, a more stable operation can be achieved by stepped changes in partial load levels.

As described above, the method of acquiring the value of the smoothed or averaged power load change and further discrete is determined in advance, and the real load at the time of starting the service operation is detected thereby to set the aforementioned target electric energy. Incidentally, the damage to the fuel cell stack is avoided by gradually increasing the amount of current controlled up to the target value.

In the determination of the advisability as to whether the service operation is to be started according to the first embodiment of the invention, as soon as it is determined that the service operation can be started, the current is controlled by the power conversion unit up to a predetermined target electric energy from the fuel cell stack. Also, the target electric energy is determined based on the value obtained by smoothing the power load change and making the smoothed value discrete. Therefore, the load-following operation can be smoothly started even in a service operation environment subjected to a large load change. The current is recovered from the fuel cell stack by being controlled up to a predetermined target electric energy value under the current control operation of the inverter constituting the power conversion unit.

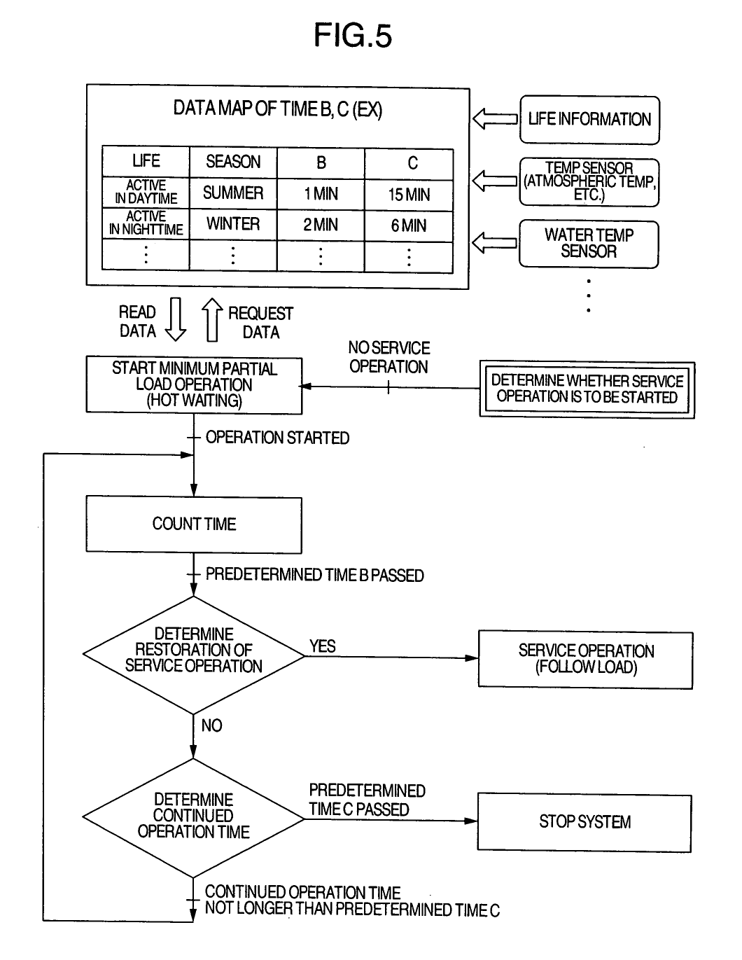

FIG. 5 shows the state transition after the minimum partial load operation (hot standby operation) of the fuel-cell power system according to a second embodiment of the invention. In the case where it is determined that the service operation cannot be started by the method of determining the advisability of the service operation start according to the first embodiment of the invention, the partial load operation (minimum partial load operation) associated with the minimum output, of all the partial load operations assumed in advance, is started as a hot waiting mode. The time count is started upon complete transition to the partial load operation.

Upon the lapse of a predetermined time B on the time counter, the advisability to restore the service operation from the minimum partial load operation is determined. This determination is made by the method explained with reference to FIG. 3. In the case where the restoration of the service operation is possible, a predetermined load operation is started as a service operation. The predetermined load is set by the method explained with reference to FIG. 4. The predetermined load includes a rated load and a partial load other than the minimum partial load.

In the case where the service operation cannot be restored, on the other hand, the minimum partial load operation is continued. In that case, the total time of the continued minimum partial load operation is calculated to determine whether the predetermined time C is not exceeded or not. This is because the minimum partial load operation, though adapted to avoid frequent stops and restarts of the system, adversely affects the power generation efficiency. In the case where the minimum partial load operation is continued for longer than a predetermined time, therefore, the system efficiency would be reduced. In the case where it is determined that the predetermined time C is exceeded, the process of stopping the system is executed. In the case where the minimum partial load operation is not continued for longer than the predetermined time C, on the other hand, the minimum partial load operation is continued and the time count is started again. Upon lapse of longer than the predetermined time C, the process of stopping the system may be executed.

The predetermined time B and C depend on the demand for power and hot water on the one hand and probably on the life pattern of the user on the other. In view of this, the values of the predetermined time B and C are changed based on the information of the temperature sensor for measuring the atmospheric temperature, the water temperature sensor for measuring the temperature of tap water and the information on the life of the user.

The difference of the season can be determined by the temperature sensor and the water temperature sensor in a manner similar to the first embodiment of the invention described above. The life information, on the other hand, includes several typical life patterns based on the information as to whether the user is active during the daytime or nighttime, whether he is a salaried man or carries on his own business and other information. These information are prepared in advance and selected by the user freely. As an alternative, the change in the operation and the required load change of the fuel-cell power system are learned and the result of learning is used as the life information.

The predetermined time B, C is prepared as a map or a function for each life pattern or each season. The data map shown in FIG. 5 is an example. The time described this data map is chosen for explanation. In the case where a man active in daytime operates the system in summer, for example, the advisability of restoring the service operation is determined for each minute after the minimum partial load operation is started, and the system is stopped upon the lapse of a total of at least 15 minutes. The power demand is high in summer, and therefore the advisability of restoring the service operation is determined with comparative frequency. In order to limit the number of times the system is started or stopped to about once per day, on the other hand, the tolerable continued operation time represented by the predetermined time C is set somewhat longer. In the case where a man active during the nighttime operates the system in winter, the advisability of restoring the service operation is determined for each two minutes after the minimum partial load operation is started, and upon lapse of six minutes, the system is stopped.

It is assumed that demand for power and hot water rises mainly during the nighttime of winter, and when demand ceases, the system should be stopped until the next morning. Since the demand for power and hot water undergoes only a small change, the length of the determination period B for restoring the operation is set to a somewhat large value. Since it is determined that the user has gone to bed as soon as demand ceases, on the other hand, the length of the predetermined time C constituting the tolerable continued operation time is set to a somewhat small value. The predetermined time B, C may be set and input by the user himself. In the case where the preset time is equal to the time set by the user, the time set by the user is given priority. In this way, the system operation satisfactory to the user is realized. The predetermined time B, C, like the predetermined time A, may be switched based on the information other than the atmospheric temperature, the water temperature and the life pattern of the user.

In the case where the service operation is difficult to start after state transition to the minimum partial load operation (hot waiting operation) of the fuel-cell power system according to the second embodiment of the invention, the system is transited to the minimum partial load operation. At the same time, the advisability of restoring the operation from the minimum partial load operation (hot waiting operation) is determined for each predetermined time B, and in the case where the restoration is difficult, the system can be stopped for each predetermined time C. The adjustment of the predetermined time B, C in automatic fashion or by the user, therefore, makes possible the efficient operation. This operation method is applicable generally not only at the time of starting the system but also in the case where the system operation cannot be continued.

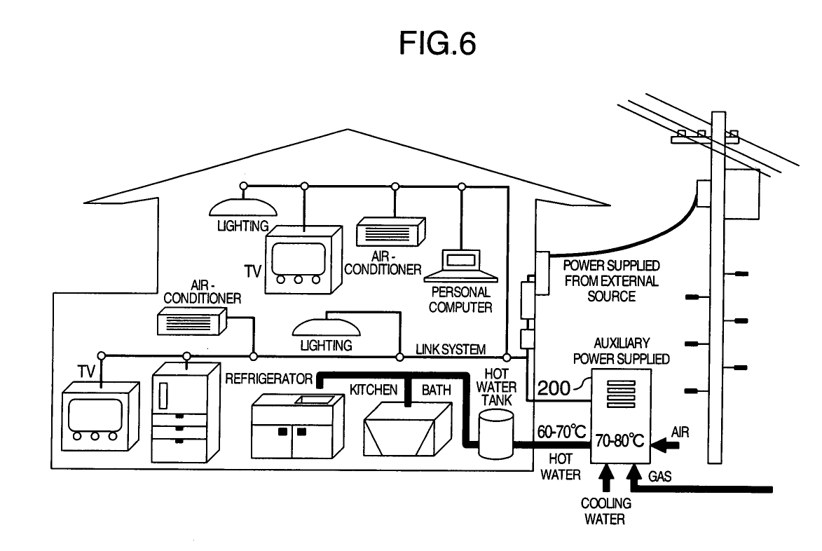

FIG. 6 shows an application of the fuel-cell power system according to the invention to a stationary distributed power supply system arranged in each home. Numeral 200 designates a stationary distributed power supply including at least the fuel-cell power system according to the invention. In this system, the hydrogen production unit produces hydrogen using the pure water generated as the result of power generation by the fuel cell or the ion exchange water produced from the tap water. The gas constituting the raw material is either the natural gas containing methane as a main component or the city gas. The propane gas or other fuel may be supplied from the cylinder. In the case where the city gas is used, the sulfur contained in the odorant is known to poison the catalyst, and therefore the city gas is supplied to a catalyst reaction unit through the desulfurizer.

The temperature in the proton-exchange membrane fuel cell (PEFC) is about 70 to 80° C. at the time of power generation, and the internal temperature of the fuel cell is regulated using the cooling water or the like. The extraneous heat generated by the reaction of the fuel cell or the internal resistance is recovered by cooling thereby to obtain hot water. In the case where the water supplied from an external source is used directly for cooling the fuel cell, however, the impurities contained in the cooling water may adversely affect the fuel cell. In such a case, the water supplied from the external source is indirectly increased in temperature by use of a means having the function of heat exchange.

The water increased in temperature reaches about 50 to 60° C., and therefore can supply hot water in place of a water heater for use in the kitchen, bath or toilet. In addition, the power generated in this way, together with the power supplied from an external source, can be used for operating various home electric appliances, and therefore the amount of power supplied from external sources can be reduced. In the case where a sufficient capacity of power generation is available, the power supplied from an external source is not required.

In the case where the water supplied from an external source is low in temperature and the temperature of the hot water obtained by heat recovery is low, or in the case where the water temperature in the hot water tank decreases, an additional heating unit may be used. This additional heating unit is adapted to increase the water temperature by combusting part of the fuel gas supplied from an external source. The water supplied from the external source can be heated and maintained at a predetermined temperature by feedback control for regulating the heating capacity or the flow rate of hot water. A similar system can be configured by combination with a gas reheater available on the market.

With the home fuel-cell power system using a fuel-cell power system according to this invention, the anode off-gas corresponding to the partial load operation can be refluxed and combusted even before starting the service operation. Therefore, the thermal balance of the hydrogen production unit can be easily achieved together with the combustor. By carrying out this process before starting the service operation, even the home load subjected to a great change can be followed in stable fashion.

Also, the load-following operation can be smoothly performed without imposing any unreasonable burden on the hydrogen production unit, and therefore the service life of the catalyst used for the hydrogen production unit is prevented from being shortened.

It should be further understood by those skilled in the art that although the foregoing description has been made on embodiments of the invention, the invention is not limited thereto and various changes and modifications may be made without departing from the spirit of the invention and the scope of the appended claims.

1. A fuel-cell power system comprising:
a fuel cell stack;
a power conversion unit controlling a current from said fuel cell stack;
a hydrogen production unit supplying hydrogen to said fuel cell stack; and
an operation unit carrying out an operation with a simulated or dummy load connected for selected one of an arbitrary time and a predetermined time A before the service operation of the fuel-cell power system.

2. A fuel-cell power system comprising:
a fuel cell stack;
a power conversion unit controlling a current from said fuel cell stack;
a hydrogen production unit supplying hydrogen to said fuel cell stack; and
a continuation unit continuing an operation with a simulated or dummy load connected for selected one of an arbitrary time and a predetermined time A before the service operation of the fuel-cell power system until the state of the hydrogen production unit is stabilized.

3. A fuel-cell power system comprising:
a fuel cell stack;
a power conversion unit controlling a current from said fuel cell stack;
a hydrogen production unit supplying hydrogen to said fuel cell stack; and
a combustion unit combusting by refluxing the anode off-gas of said fuel cell stack to the combustor of said hydrogen production unit in the operation with a simulated or dummy load connected before the service operation of the fuel-cell power system.

4. A fuel-cell power system according to claim 1,
wherein selected one of the arbitrary time and the predetermined time A is changed based on at least one of the atmospheric temperature, a water temperature, a reformed catalyst temperature and number of times the system is started and stopped.

5. A fuel-cell power system according to claim 1,
wherein selected one of the arbitrary time and the predetermined time A is sustained until the state of the hydrogen production unit and the fuel cell stack is stabilized.

6. A fuel-cell power system according to claim 1, further comprising at least selected one of a power storage unit and a hot water storage unit,
wherein advisability of starting the service operation is determined by reference to at least selected one of an amount of hot water stored in the hot water storage unit and an amount of power stored in the power storage unit.

7. A fuel-cell power system according to claim 1,
wherein upon determination that the service operation cannot be started, a predetermined partial load operation is started thereby to suppress an amount of power generation and heat recovery.

8. A fuel-cell power system according to claim 1,
wherein upon determination that the service operation can be started, the current is controlled by said power conversion unit up to a target output power calculated based on the value of the smoothed or averaged power load change.

9. A fuel-cell power system according to claim 1,
wherein the amount of hydrogen produced by the operation with said simulated or dummy load connected is set to a value smaller than the amount of hydrogen produced during the rated operation of the system.

10. A fuel-cell power system according to claim 1,
wherein said simulated load is a power storage unit.

11. A fuel-cell power system according to claim 10,
wherein at least part of the power supplied to an auxiliary equipment required for starting the system is acquired from said power storage unit.

12. A fuel-cell power system comprising:
a fuel cell stack;
at least one of a power storage unit and a hot water storage unit;
a determination unit determining advisability of starting or continuing service operation by reference to at least selected one of an amount of hot water stored in said hot water storage unit and an amount of power stored in said power storage unit;
a start unit starting a predetermined partial load operation and repeatedly determining the advisability of restarting the service operation for selected one of each arbitrary time and each predetermined time B in the case where said advisability determining unit determines that the service operation cannot be started; and
a stop unit stopping the system upon lapse of selected one of an arbitrary time and a predetermined time C as long as the repeated determination of the advisability to restart the operation remains negative.

13. A fuel-cell power system according to claim 12,
wherein at least selected one of the arbitrary time and the predetermined time B and C is changed based on at least selected one of an atmospheric temperature, a water temperature and information on the life pattern of an user.

14. A home fuel-cell power system comprising the fuel-cell power system according to claim 1.

15. A fuel-cell power system comprising:
a fuel cell stack;
a power conversion unit controlling a current from said fuel cell stack;
a hydrogen production unit supplying hydrogen to said fuel cell stack; wherein
upon determination that service operation cannot be started or continued, a predetermined partial load operation is started thereby to suppress an amount at a power generation and heat recovery.
